(19) United States
(12) Patent Application Publication
(10) Pub. No.: US 2013/0026694 A1
(43) Pub. Date: Jan. 31, 2013

(54) FLYSHEET FOLDER AND METHOD OF FOLDING

(71) Applicants: John Sheridan Richards, Barrington, NH (US); Jean Claude Pautrat, Shanghai (CN); Didier Havard, Nantes Cedex (FR)

(72) Inventors: John Sheridan Richards, Barrington, NH (US); Jean Claude Pautrat, Shanghai (CN); Didier Havard, Nantes Cedex (FR)

(73) Assignee: GOSS INTERNATIONAL AMERICAS, INC., Durham, NH (US)

(21) Appl. No.: 13/539,881

(22) Filed: Jul. 2, 2012

Related U.S. Application Data
(60) Provisional application No. 61/503,270, filed on Jun. 30, 2011.

(51) Int. Cl. B41F 13/56

(52) U.S. Cl. 270/21.1

(57) ABSTRACT

A digital printing press is provided. The digital printing press includes at least one digital printing unit printing on a web, at least one cutting cylinder cutting the web into panorama sheets and flysheets and a folder for folding the panorama sheets cut from the web. The folder includes a flysheet cylinder for receiving flysheets printed and cut from the web, a collect cylinder for accumulating at least one panorama sheet and at least one flysheet at a collect location and a folding cylinder for folding panorama sheets received from the collect cylinder into a section. Methods are also provided.

Priority is hereby claimed to U.S. Provisional Patent Application No. 61/503,270 filed on Jun. 30, 2011, the entire disclosure of which is hereby incorporated by reference herein.

The present invention relates to printing presses and more particularly to folders in a printing press.

### BACKGROUND

In broadsheet newspaper printing, half panorama sheets, also known as flysheets, are commonly used so the number of pages can be selected in multiples of two, e.g. 4, 6, 8, 10 . . . , instead of in multiples of four, e.g., 4, 8, 12 . . . provided by panorama sheets. Conventional flysheets are printed across half the width of the web and lay perpendicular to the direction of web travel.

Digital printing presses do not require the use of printing plates and thus have a quicker and less expensive turnaround time than traditional lithographic and flexographic printing presses. Digital printing presses can produce different images in successive revolutions if a digital print unit is being used including for example, direct imaging pages in an offset printing press. The use of digital printing presses also allows multiple pages to be produced sequentially on a single web by only one printing device.

### SUMMARY OF THE INVENTION

When digital printing presses are printing images on web across the direction of web travel traditional methods of producing flysheets, that is, using sheets that are half of a web width, cannot be used. As a result, digital printing presses cannot easily incorporate the flexibility flysheets provide.

The present invention provides a digital printing press. The digital printing press includes at least one digital printing unit printing on a web, at least one cutting cylinder cutting the web into panorama sheets and flysheets and a folder for folding the panorama sheets cut from the web. The folder includes a flysheet cylinder for receiving flysheets printed and cut from the web, a collect cylinder for accumulating at least one panorama sheet and at least one flysheet at a collect location and a folding cylinder for folding panorama sheets received from the collect cylinder into a section.

The present invention advantageously provides a way in which flysheets can be used with digital printing presses. A web may be printed with columns or images across the direction of web travel that include a page and section makeup identical to conventional printed products, thereby incorporating flysheets.

The present invention advantageously provides a way to digitally produce a plurality of flysheets and store the plurality of flysheets on a cylinder in a folder of a printing press. When a flysheet is needed, the flysheet is forwarded to the next panorama page until each flysheet is used. A new set of flysheets may then be printed and stored for future use in another section of the newspaper.

### BRIEF DESCRIPTION OF THE DRAWINGS

A preferred embodiment of the present invention is described below by reference to the following drawings, in which:

FIG. 1 shows a printing press in accordance with the present invention;

FIG. 2 shows a panorama sheet printed in accordance with present invention;

FIG. 3 shows a flysheet printed in accordance with the present invention;

FIGS. 4 to 6 show flysheet and panorama production for different sized sections in accordance with the present invention;

FIGS. 7 and 8 show a folder forming different sized sections in accordance with the present invention;

FIG. 9 shows another preferred embodiment of a folder forming a newspaper section in accordance with the present invention; and

FIG. 10 shows an accumulator and chopper in accordance with the present invention;

### DETAILED DESCRIPTION

A printing press according to the present invention is configured to produce printed products such as newspapers, for example, tabloid or broadsheet newspapers, from a web containing pages printed sequentially on one web. The pages are printed in a sequence needed to produce the desired final newspaper. The number of sections per newspaper and the number of pages in each section are fully variable in accordance with a preferred embodiment of the present invention.

Broadsheet newspapers printed on a digital printing press are produced with the newspaper columns laid out across the length of a web, along the direction of web travel. The vertical spine of the broadsheet newspaper is produced by a folding cylinder, for example, a jaw folder, by a fold extending across the web. The horizontal fold across the middle of the height of the broadsheet newspaper is made parallel with the direction of web and product travel. The second fold may be produced by a further folding cylinder, for example, a quarter folder or chopper. Tabloid newspapers printed on a digital printing press are also produced with the newspaper pages laid out across the length of the web, along the direction of web travel. The vertical spine of the tabloid newspaper is produced by a folding cylinder, for example, in jaw folder, by a fold extending across the web. As known in the art, tabloid newspapers usually include only one fold, the vertical spine.

A printing press in accordance with the present invention includes a folder that cuts the web into sheets, receives, stores and inserts flysheets as desired, collects pages for each section and jaw folds each section. Each sections of a multi-section product is accumulated and stacked together then the stacks are cross folded and delivered as complete newspapers or other multi-section products. If a single section product or tabloid newspaper is desired the jaw folded section is the complete product. The jaw folded section may be passed to a fan wheel, slowdown device or other conveyor for further processing and downstream transport.

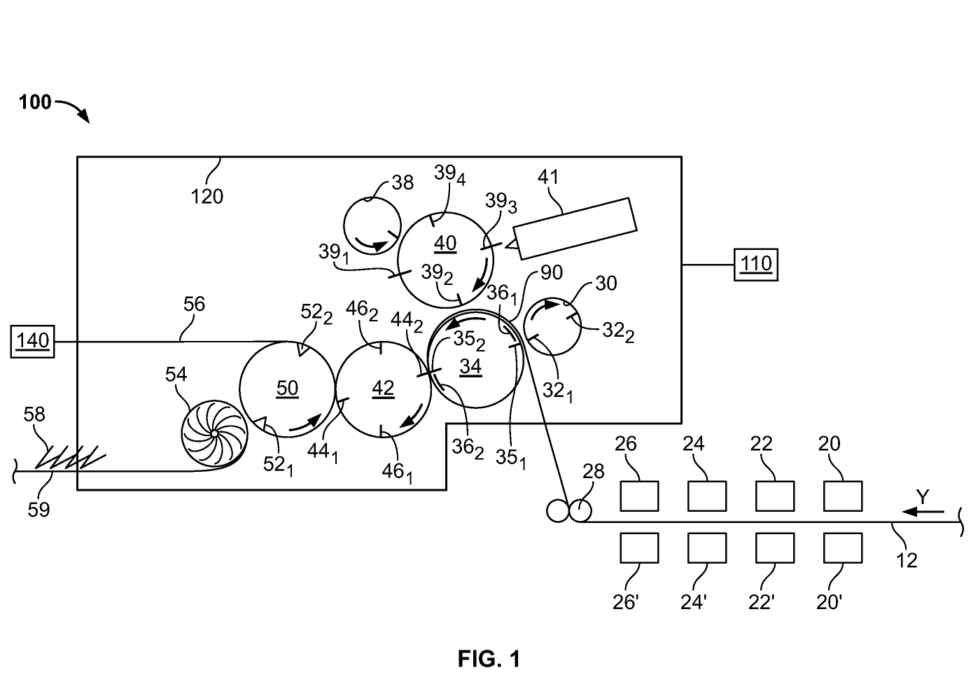

As shown in FIG. 1, a printing press 100 includes a plurality of printing units 20, 20′, 22, 22′, 24, 24′, 26, 26′ arranged on both sides of a web 12 for printing on both sides of web 12. Web 12 travels in a direction Y. Printing units may be, for example, digital print units, including, for example, direct imaging print units, ink jet print units or laser print units. Printing press 100 may be an offset press or digital print engines may print directly on web. Preferably, press 100 includes digital print engines 20, 20′ 22, 22′, 24, 24′, 26, 26′ located on either side of web 12 for printing on both sides of web 12 as web 12 travels in direction Y. The number of digital print engines may vary as desired.

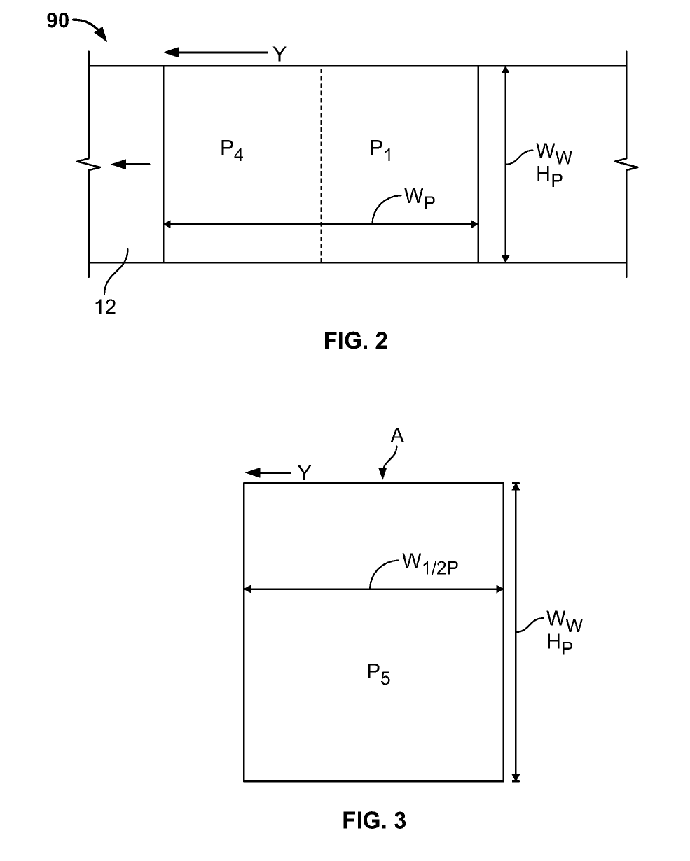

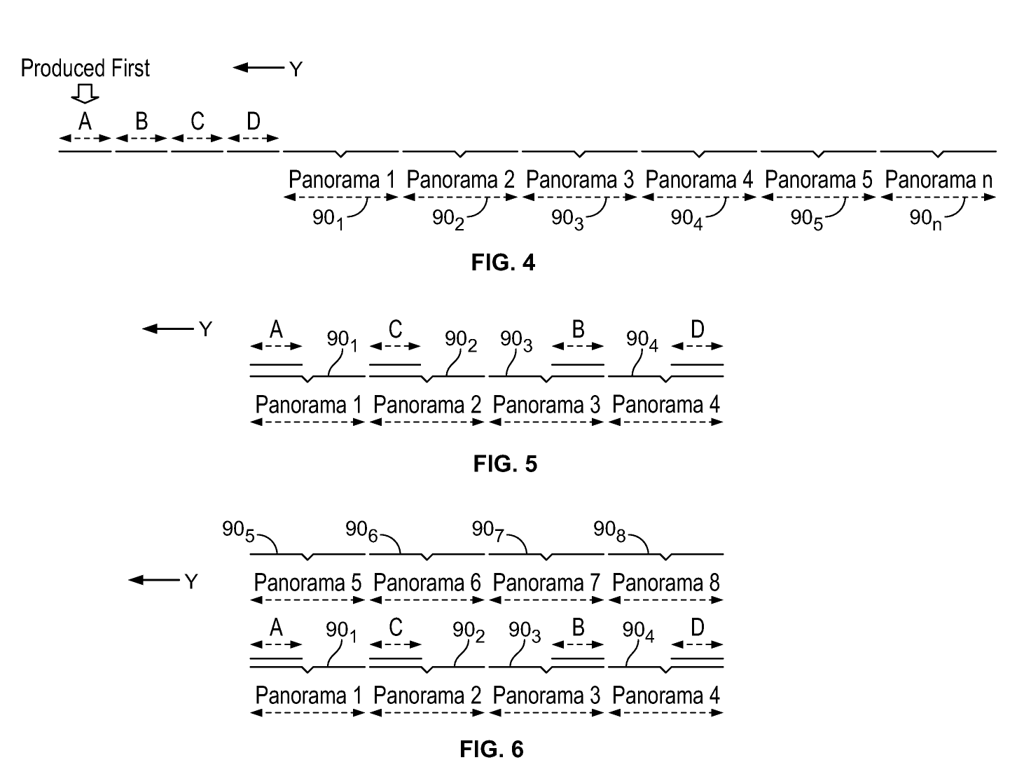

As discussed above and shown in FIGS. 2 and 3, sheets are printed with images printed along the length of web 12, in the direction of web travel Y, thereby producing a panorama sheet 90. As a result, panorama sheet 90 has a height H_{P} equal to a width of web 12 (W_{W}) and a width (W_{P}) which is two pages wide. Pages are identified as P1 and P4. The other side panorama sheet 90 is printed with pages P2 and P3, respectively. Thus, each panorama sheet 90 includes four pages P1 to P4 of the final printed product or newspaper. Panorama sheet 90 is cut from web 12 and folded once to form a section or ultimately folded twice when producing, for example, a broadsheet newspaper. Flysheets A, B, C, D (FIG. 4) are provided so each product or newspaper section can have a page count that is variable in multiples of two as opposed to multiples of four provided by panorama sheets 90. As shown in FIG. 3, the flysheets (illustrated by flysheet A) have a width (W_{P*1/2}) equal to one broadsheet page P₅ or half a panorama sheet (W_{P}). Wider web widths may also be used. Wider web widths may accommodate printing of a plurality of rows of panorama sheets across the web. For example, a double wide web, may a have a web width of W_{2W} which would be equal to 2H_{P}.

As shown in FIG. 1, after printing on web 12, nip rolls 28 and/or turner and angle bars may be used to direct and support web 12 to folder 120. Folder 120 includes a one-around cutting cylinder 30. As known in the art, a one-around cylinder has a circumference which supports a single sheet, in this case, a single panorama sheet 90. Folder 120 also includes a two-around transfer cylinder 34, which supports two sheets 90 around the circumference thereof, a two-around collect cylinder 42 and a two-around jaw cylinder 50. Folder 120 may also include a fan wheel 54 and a one-around flysheet cut cylinder 38. Other embodiments and configurations of folder 120 are also possible. A controller 110 may be provided to control components of folder 120 and/or press 100.

Web 12 enters folder 120 and is cut into panorama sheets 90 by a cutting cylinder 30 having cutting or knife blades 32₁, 32₂. Blades 32₁, 32₂ cut against cutting rubbers 36₁, 36₂ on transfer cylinder 34. Blades 32₁, 32₂ may be retractable. A second cutting blade 32₂ may only cut flysheets from web 12, while a first blade 321 may cut panorama sheets 90_{N}. Transfer cylinder 34 also includes two grippers which may be, for example, pins 35₁, 35₂, other mechanical grippers or vacuum grippers. Pins 35₁, 35₂ hold a lead edge of web 12 while knife blade 32₁ cuts web 12 at a trailing edge of a newly formed panorama sheet 90. Thus, cutting cylinder 30 cuts web 12 into panorama sheets 90 against transfer cylinder 34. The newly formed panorama sheets 90 remain gripped by transfer cylinder 34. When flysheets are desired, flysheets are printed on the web in groups of four, sequentially A, B, C, D. Panorama sheets 90 may be produced sequentially in any quantity, from one panorama sheet up to a maximum number of panorama sheets desired in a section.

In accordance with a feature of the present invention, flysheets A, B, C, D are printed on web 12, cut into flysheets A, B, C, D by blade 32₂ on cutting cylinder 30 and transferred via transfer cylinder 34 to flysheet cylinder 40. Flysheets are stored on flysheet cylinder 40 until flysheets A, B, C, D are needed during compilation of a newspaper section. Panorama sheets 90 are cut by cutting cylinder 30 against transfer cylinder 34 and transferred from transfer cylinder 34 to collect cylinder 42. Transfer cylinder 34 provides at least two advantages. First, transfer cylinder 34 selectively transfers flysheets A, B, C, D to flysheet cylinder 40 and panorama sheets 90 to collect cylinder 42. Second, transfer cylinder 34 provides a surface and cutting rubber 36 for sheets 90 to be cut against. This cutting surface eliminates cutting against previously collected sheets 90 on collect cylinder 34 and the additional, undesirable cuts associated therewith, also known in the art as macaroni.

At the beginning of printing a new group of sections, flysheets are produced. In this example, four sections being produced at a time. Four flysheets A, B, C, D are printed if flysheets are needed in any of these four sections. Cutting cylinder 30 may selectively cuts the four flysheets A, B, C, D apart. Flysheets A and C are held on the flysheet cylinder 40 by pins 39₁, 39₃, while flysheets B and D are held on the flysheet cylinder 40 by vacuum grippers 39₂, 39₄ (pins would impale later passing sheets). Alternatively, A through D could each be held on by vacuum grippers.

FIG. 4 shows the sequential production of four flysheets A, B, C, D followed by a plurality of panorama sheets 90_{N} printed on web 12 and subsequently cut into sheets. Flysheets are identified as A, B, C and D with A being the first one printed on the web in the direction of travel Y and transferred first to the flysheet cylinder, and D being the last of the four. FIG. 5 shows each flysheet A, B, C, D lying on top of a corresponding panorama sheet 90, 90₂, 90₃, 90₄. Each panorama sheet/fly sheet combination thereby forms a six-page section consisting of the four pages supplied by the single panorama sheet 90_{N} and the two pages supplied by the corresponding flysheet, for example panorama sheet 90₁ and flysheet A. FIG. 6 shows panorama sheets 90, 90₂, 90₃, 90₄, having a corresponding flysheet A, C, B, D and an additional panorama sheet 90₅, 90₆, 90₇, 90₈ collected thereon. Each section thereby including two panorama sheets 90_{N} and a flysheet, for example, panorama sheets 90₁, 90₅ and flysheet A, forms a ten-page section.

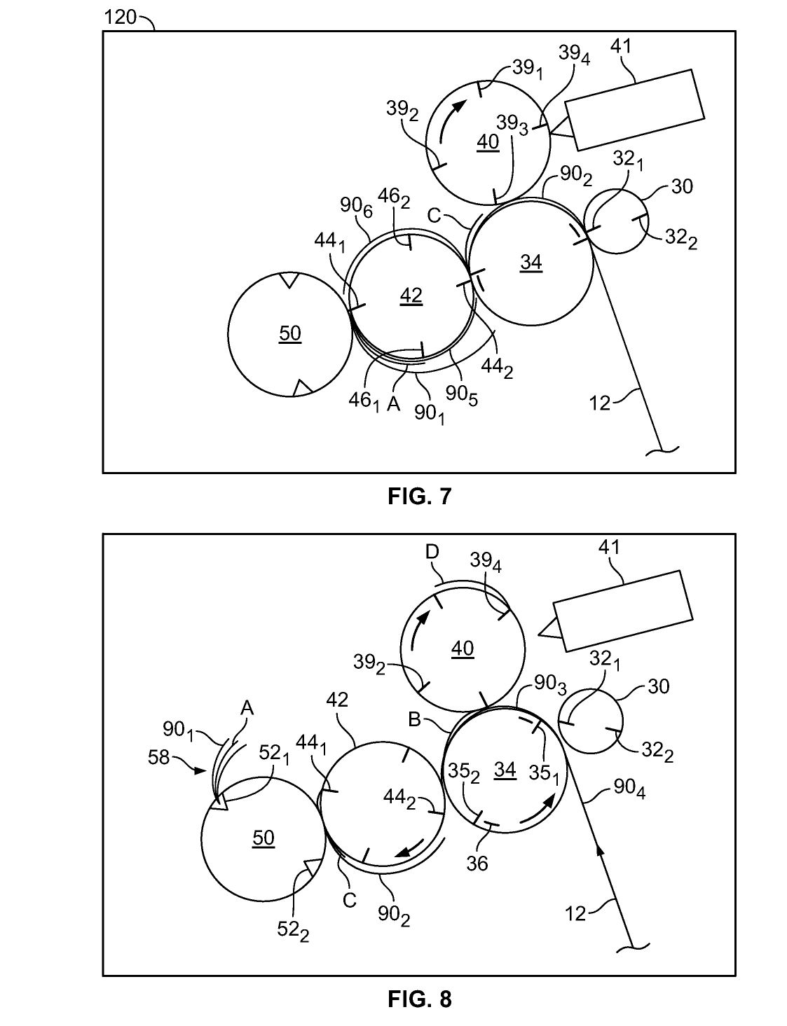

Flysheets A, C are transferred to the lead edge of a panorama sheet 90₁, 90₂, respectively, onto pins 35₁, 35₂ of transfer cylinder 34 (FIG. 7) that are forwarding panorama sheets 90₁, 90₂. The phasing of flysheets B and D on the flysheet cylinder is such that these two flysheets will be laid onto the trailing half of their respective panorama mates 90₃, 90₄. (See FIG. 8). Since pins 35₁, 35₂ are not available on transfer cylinder 34 at this location, glue is placed onto the leading edge of the flysheet B, D, so flysheets B, D can be forwarded with the panorama sheets 90₃, 90₄ to collect cylinder 42 via transfer cylinder 34. Glue may be provided from an applicator 41 or any means known in the art.

Flysheets A, C, B, D are delivered to their corresponding panorama mate 90, 90₂, 90₃ 90₄ . . . while the panorama sheets 90, 90₂, 90₃ 90₄ are on transfer cylinder 34. Panorama sheets 90, 90₂, 90₃ 90₄ . . . , together with any corresponding flysheet, are transferred to collect cylinder 42. Collect cylinder 42 includes pins 44₁, 44₂ or grippers (mechanical grippers, vacuum, etc.) for collecting sheets on cylinder 42. Additional panorama sheets 90_{N} may be collected to form a newspaper section. When desired, the collected sheets at each pin 44₁, 44₂ are tucked into a jaw 52₁, 52₂ of jaw cylinder 50 by a tucking blade 46₁, 46₂ on collect cylinder 42 forming a cross fold. This cross fold is the first fold made in the newspaper section; the fold is made across the width of the web, and is the vertical fold of the final broadsheet newspaper.

As shown in FIG. 7, at a first pin 44₁ a panorama sheet 90₁ and flysheet A pinned thereto is delivered to a previously collected panorama sheet 90₅. At a second pin location 44₂, a second panorama sheet 90₂ and flysheet C is about to be delivered to a previously collected panorama sheet 90₆. Panorama sheet 90₂ is receiving flysheet C while on transfer cylinder 34 and panorama sheet 90₂ is also being cut from web 12 at the trail edge via cut cylinder 30. At each pin location 44₁, 44₂, a 10 page section will be formed, each section including two panorama sheets and a flysheet.

FIG. 8 shows the formation of newspaper sections 58. One newspaper section 58, is folded in jaw 52₁ and a second section will be formed at jaw 52₂. The section 58 at jaw 52₁ includes a flysheet A and a single panorama sheet 90₁ thus forming a six page section. Similarly, the section to be formed at jaw 52₂ includes a flysheet C and a panorama sheet 90₂ also forming a six page section.

A section 58 including panorama sheet 90₁ and flysheet A is shown folded into a jaw 52₁ of jaw cylinder 50 for further downstream delivery. At a first pin location 44₁ on collect cylinder 42, panorama sheet 90₂ and flysheet C are about to be folded off and tucked into a jaw 52₂ to form a second section. At a second pin 44₂ on collect cylinder 40, panorama sheet 90₃ has just been collected. Panorama sheet 90₃ includes a flysheet B glued thereto. Panorama sheet 90₃ received flysheet B from a vacuum gripper 39₂ on flysheet cylinder 40 while panorama sheet 90₃ was still on transfer cylinder 34. A fourth panorama sheet 90₄ will be cut from web 12 and will receive a flysheet D from vacuum gripper 39₄ when panorama sheet 90₄ is around transfer cylinder 34. Since flysheets B, D are applied to the trailing half of panorama sheets 90₃, 90₄, and pins are not available on transfer cylinder 34 at this position, glue, or another adhesive, is used to adhere flysheets B, D to panorama sheets 90₃, 90₄. Glue applicator 41 will apply glue or multiple glue spots to a leading edge of flysheets B, D so flysheets B, D can adhere to corresponding panorama sheets 90₃, 90₄.

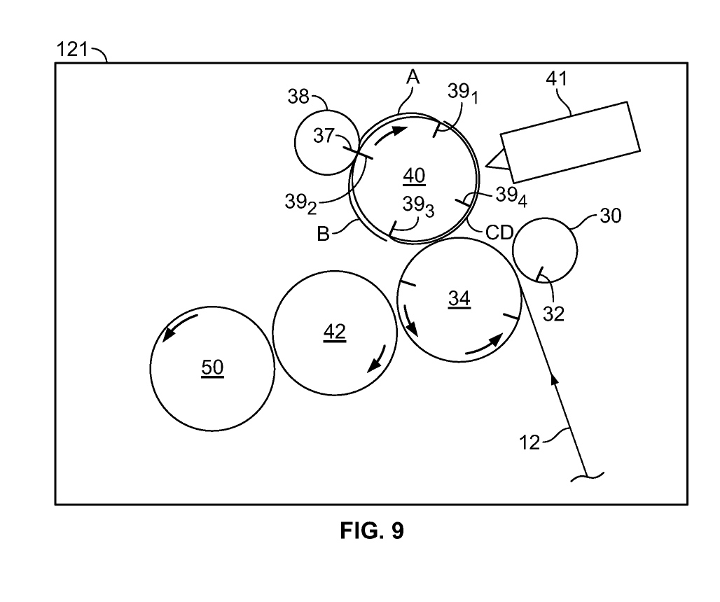

FIG. 9 shows another preferred embodiment in accordance with the present invention. A folder 121 for printing press 100 further includes a one-around flysheet cutting cylinder 38 having a cutting blade 37. Elements shown in FIGS. 7 and 8 and discussed above that perform in the same manner will not be discussed with respect to FIG. 9. In this embodiment, cutting cylinder 30 cuts two panorama sized flysheets AB, CD from web 12 as opposed to cutting four individual flysheets A, B, C, C. Each panorama sized sheet AB, CD is two flysheets wide by one flysheet tall, as opposed to four flysheets each being one flysheet wide by one flysheet tall.

In this manner, two panorama sized flysheets AB, CD are pinned to flysheet cylinder 40, for example at grippers 39₁, 39₃. Thus, cutting cylinder 30 and transfer cylinder 34 are cutting panorama sized sheets from web 12 regardless of whether or not the web is printed with flysheet pages AB, CD or panorama sheet pages 90, 90_{N}. When panorama sized flysheets AB, CD stored on flysheet cylinder 40 need to be cut into individual flysheets A, B, C, D, cutting blade 37 on flysheet cylinder 38 cuts panorama sized flysheet AB into two individual flysheets A and B and similarly cuts panorama sized flysheet CD into two individual flysheets C and D. Flysheets B, D may be held on flysheet cylinder 40 by, for example, vacuum grippers 39₂, 39₄. Flysheets A, B, C, D can then be combined with panorama sheets 90, 90_{N} on transfer cylinder 34 in the manner discussed above.

As shown in FIGS. 7 to 9, each flysheet A, C, B, D is placed on top of a corresponding panorama sheet, 90, 90₂, 90₃, 90₄ when the panorama sheet is on transfer cylinder 34 and each flysheet A, C, B, D will be underneath its corresponding panorama sheet, 90, 90₂, 90₃, 90₄ when each flysheet A, C, B, D is on collect cylinder 42. Consequently, flysheets A, C, B, D will always be tucked inside the corresponding panorama sheets 90, 90₂, 90₃, 90₄ when the sheets 90, 90₂, 90₃, 90₄ are jaw folded.

During the formation of the previous described sections, two identical copies of each section are produced. One identical section is formed at each pin location 44₁, 44₂ on collect cylinder 42. Each of these sections 58 may be combined with other non-identical sections to form a multi-section product or newspaper. Since digital printing allows for flexibility and variability in printing images on the web, it is also possible to use the flysheet cylinder to vary the number of pages in the sections. For example, flysheet cylinder 40 may transfer flysheets A, C to panoramas in a section while flysheets B, D are held on the flysheet cylinder to be combined later. Thus providing sequential sections with the following page counts, 6 pages (with flysheet A), 6 pages (with flysheet C), 4 pages (no flysheet), 4 pages (no flysheet).

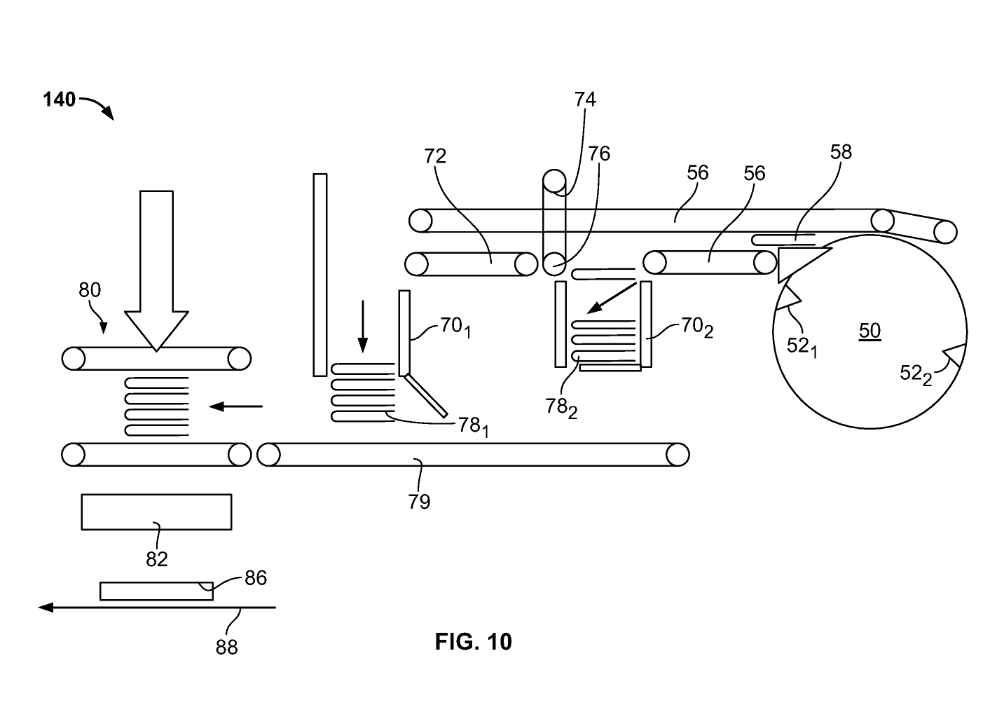

If only one section is desired, for example, when forming a tabloid newspaper product, the folded newspaper section may be transferred, slowed and shingled via a fan wheel 54 (FIG. 1). Alternatively, sections 58 may be transported unshingled further downstream to an accumulator 140 via a delivery belt 56. (See FIGS. 1 and 10).

FIG. 10 shows an accumulator section 140 for forming multi-section products, for example, broadsheet newspapers. When a multi-section newspaper is desired each cross-folded section 58 is transported from jaw cylinder 50 downstream to an accumulator section 140 via delivery belts 56. The accumulator section 140 may include two accumulators 70₁, 70₂, for accumulating the sections 58. The accumulator section 140 may also include a plurality of conveyors 72, 74, such as belts or tapes, and rollers 76 for delivering each section 58 to a corresponding accumulator 70₁, 70₂. As shown in FIG. 10, conveyor 74 may be rotatable. In the position, shown in FIG. 10, conveyor 74 is perpendicular to the direction of travel of section 58 and guides jaw folded sections to accumulator 70₂ for stacking. When conveyor 74 is rotated clockwise 90° about roller 76, conveyor 74 lays flat and guides sections 58 to accumulator 70₁ for stacking. The accumulators 70₁, 70₂ each receive further sections 58 from folder 120 and form stacks 78₁, 78₂. In a multi-section product, each section 58 may comprise one section of the newspaper, for example, sports, business, entertainment, etc. The different jaw folded sections 58 are accumulated and stacked together to form a final product, for example, a complete broadsheet newspaper 86. Thus, stacks 78₁, 78₂, when compete, each include all of the individual sections of a final product or newspaper 86.

Each accumulator 70₁, 70₂, must keep stacks 78₁, 78₂ in alignment. Once stacks 78₁, 78₂ are fully assembled in the accumulators 70₁, 70₂, each stack 78₁, 78₂ is transferred to a second conveyor 79 for forwarding to a chopper folder 80 if a further fold is desired. The second conveyor 79 must keep the accumulated stacks 78₁, 78₂ in proper alignment during delivery to chopper folder 80 and through the chopper folding process. Chopper folder 80 cross folds each stack 78₁, 78₂ into a final product or final newspaper 86 and deposits newspapers 86 on a conveyor 88. The chopper fold is, for example, the horizontal fold located across a middle of a broadsheet newspaper. The chopper folder 80 may be similar to those known in the art and include a chopper blade and two chopper cylinders 82. The second conveyor 79 may include transport tapes or belts as known in the art.

With respect to tabloid newspaper products, printing press 100 can produce true tabloid style products by providing a web having the appropriate width and desired cutoff. Single section tabloid newspapers or other single section products are be formed on collect cylinder 42 and folded on jaw cylinder 50. In this configuration, flysheet cylinder 40 may be included when page breaks in multiples of two are desired, however, flysheet cylinder 40 may be eliminated or bypassed when page breaks in multiples of four are acceptable. Tabloid products are formed by collecting the desired number of panorama sheets 90_{N} and any desired flysheets A, B, C, D on each pin 44₁, 44₂ of collect cylinder 42. Thus, each pin 44₁, 44₂ includes a completely collected tabloid newspaper. The collection of sheets at each pin 44₁, 44₂ are then folded off into jaws 52₁, 52₂ forming sections 58 as described and shown in FIG. 9. A fan wheel 54 receives folded sections/newspapers 58 and deposits newspapers on a delivery 59 for further downstream processing and transport. Accumulator 140 and chopper folder 80 are unnecessary when forming a standard tabloid product and thus may be silenced or taken off line.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A digital printing press comprising:
at least one digital printing unit printing on a web;
at least one cutting cylinder cutting the web into panorama sheets and flysheets; and
a folder for folding the panorama sheets cut from the web; the folder including:
a flysheet cylinder for receiving flysheets printed and cut from the web;
a collect cylinder for accumulating at least one panorama sheet and at least one flysheet at a collect location; and
a folding cylinder for folding panorama sheets received from the collect cylinder into a section.

2. The digital printing press as recited in claim 1 further comprising:
a transfer cylinder receiving panorama sheets and flysheets cut from the web.

3. The digital printing press as recited in claim 2 wherein a flysheet is applied to a panorama sheet while the panorama sheet is on the transfer cylinder.

4. The digital printing press as recited in claim 1 wherein four flysheets are printed sequentially on the web.

5. The digital printing press as recited in claim 1 wherein the flysheet cylinder stores flysheets until a flysheet is combined with a corresponding panorama sheet.

6. The digital printing press as recited in claim 1 further comprising at least one accumulator for accumulating a plurality of sections.

7. The digital printing press as recited in claim 1 further comprising at least one chopper folder for further folding the plurality of sections.

8. The digital printing press as recited in claim 1 further comprising a fan wheel for shingling sections on a conveyor.

9. The digital printing press as recited in claim 1 further comprising an applicator for applying adhesive to at least one flysheet.

10. The digital printing press as recited in claim 1 wherein at least one flysheet is glued to a panorama sheet.

11. The digital printing press as recited in claim 1 wherein the collect cylinder, transfer cylinder and flysheet cylinder include a plurality of grippers.

12. The digital printing press as recited in claim 11 wherein at least one gripper is a pin gripper.

13. The digital printing press as recited in claim 11 wherein at least one gripper is a vacuum gripper.

14. The digital printing press as recited in claim 1 wherein the collect cylinder collects at least two panorama sheets and a flysheet at the collect location.

15. The digital printing press as recited in claim 1 further comprising a flysheet cutting cylinder for cutting flysheets on the flysheet cylinder.

16. The digital printing press as recited in claim 1 wherein the section is a single section of a broadsheet newspaper.

17. The digital printing press as recited in claim 1 wherein the at least one panorama is folded around the at least one flysheet.

18. The digital printing press as recited in claim 1 wherein the folding cylinder is a jaw cylinder or rotary blade folder.

19. The digital printing press as recited in claim 1 further comprising a controller for controlling the folder.

20. A tabloid newspaper printed and formed with the printing press recited in claim 1.

21. A multi-section broadsheet newspaper printed and formed with the printing press recited in claim 1.

22. A method of forming a folded printed product on a digital printing press comprising the steps of:
printing images on a web across a direction of web travel;
cutting the web into at least one panorama sheet and at least one flysheet;
transferring the flysheet from a flysheet cylinder to a corresponding panorama sheet;
collecting the panorama sheet on a collect cylinder; and
folding the panorama sheet to form a folded printed product.

23. The method of forming a printed product as recited in claim 22 further comprising the step of:
storing a flysheet on the flysheet cylinder.

24. The method of forming a newspaper as recited in claim 22 wherein the step of cutting the web into at least one panorama sheet and at least one flysheet includes using a flysheet cutting cylinder.

25. The method as recited in claim 22 wherein the at least one flysheet is half the width of the at least one panorama sheet.

26. The method as recited in claim 22 wherein the flysheet is transferred to a lead edge of the panorama sheet before the panorama sheet is collected on a collect cylinder.

27. The method as recited in claim 22 wherein the flysheet is transferred to a panorama sheet at a location other than a lead edge of the panorama sheet.

28. The method as recited in claim 22 further comprising the steps of:
transporting the folded printed product downstream;
accumulating further folded printed products in a stack;
cross folding the stack.

29. The method as recited in claim 28 wherein the stack is a broadsheet newspaper.

30. The method as recited in claim 22 wherein the folded printed product is a tabloid newspaper or a single section of a broadsheet newspaper.

31. The method as recited in claim 22 wherein the printed product is folded on a jaw cylinder.

32. The method as recited in claim 28 wherein the folded printed products are cross folded in a chopper or quarter folder.

33. A method for forming a tabloid newspaper comprising the method recited in claim 22.

34. A method for forming a broadsheet newspaper comprising the method recited in claim 28.
